(19) United States
(12) Patent Application Publication
(10) Pub. No.: US 2003/0150264 A1
(43) Pub. Date: Aug. 14, 2003

(54) Embedded automatic temperature compensating axial flow meter

(76) Inventor: Michel Malnoe, Saint-Samson (FR)

Correspondence Address: RANDALL J. KNUTH P.C., 3510-A STELLHORN ROAD, FORT WAYNE, IN, 46815-4631, US

(21) Appl. No.: 10/352,713

(22) Filed: Jan. 28, 2003

Related U.S. Application Data
(60) Provisional application No. 60/355,874, filed on Feb. 11, 2002.

(51) Int. Cl. G01F 1/68

(52) U.S. Cl. 73/204.11

(57) ABSTRACT

The present invention relates to an apparatus and method for measuring the volume of a flowing media. The apparatus includes a pulse sensor and a temperature sensor wherein the temperature sensor and the pulse sensor are utilized to provide data for calculating the volume of the flowing media.

The present application hereby claims the benefit under Title 35, United States Code §119(e) of U. S. provisional application no. 60/335,874 filed Feb. 11, 2002.

### BACKGROUND OF THE INVENTION

1. Field of the invention.

The present invention relates to an apparatus and method for measuring the volume of a flowing media. The temperature of the flowing media is used to calculate the volume of the flowing media.

2. Description of the related art.

Currently, devices used for measuring the volume of a flowing media have incurred many problems. To provide an accurate measurement, the temperature of the flowing media must be determined to calculate the volume of the flowing media. Expensive thermistors must be used to ensure an accurate measurement of the temperature of the flowing media. The use of a less expensive thermistor can provide an inaccurate temperature reading which therefore would cause the calculation for the volume of the flowing media to be inaccurate.

Some measuring devices use look-up tables with values to be added or subtracted to the temperature reading and/or volume reading to compensate for readings that may be inaccurate due to particular known circumstances. The look-up table is stored to a memory in the measuring device. To change the look-up table values, the memory chip must be removed, the updated look-up table burned to a new memory chip and the new memory chip placed into the measuring device. This can be time consuming and expensive.

The measuring devices consist of two or more components. For each component, an opening must be made in the housing of the meter. Therefore, an extra opening must be made in the meter housing for each extra component of the measuring device. Each component must be connected using cable or some other connection device. Therefore, the more components need to manufacture the measuring device, the more cables that will be needed to connect the components to the measuring device. Each additional opening in the meter housing makes the meter housing more expensive to manufacture as well as increasing the risk of leakage of the fluid flowing through the meter from the area between the component and the housing.

Also, the thermistor and its leads may provide an inaccurate reading of the temperature of the flowing media because either the thermistor, the leads, or both the thermistor and the leads are in thermal contact with the meter housing causing the temperature read by the thermistor to be inaccurate. The present invention solves these problems.

### SUMMARY OF THE INVENTION

The present invention, in one form thereof, is an apparatus for measuring the volume of a flowing media. The apparatus includes a housing having a temperature sensor and a measuring means wherein the temperature sensor and the measuring means are connected. The temperature sensor is utilized to measure the temperature of the flowing media. The temperature sensor is thermally insulated from the housing. The measuring means utilizes the measured temperature of the flowing media to measure the volume of the flowing media.

The present invention, in another form thereof, is an apparatus for measuring the volume of a flowing media. The apparatus includes a housing having a temperature sensor and a measuring means wherein the temperature sensor and the measuring means are connected. The temperature sensor is utilized to measure the temperature of the flowing media. The temperature sensor creates a resistance corresponding to the measured temperature of the flowing media. A resistance compensation means is connected to the measuring means for changing the resistance from the temperature sensor to ensure an accurate measurement of the temperature of the flowing media. The measuring means utilizes the measured temperature of the flowing media to measure the volume of the flowing media.

The present invention, in yet another form thereof, is an apparatus for measuring the volume of a flowing media. The apparatus includes a meter having a housing wherein the housing has an external segment and an internal segment. A measuring means having a pulse sensor and a temperature sensor is utilized to measure the volume of the flowing media after the measuring means is inserted into the single opening of the external segment.

The present invention, in yet another form thereof, is an apparatus for measuring the volume of a flowing media. The apparatus includes a measuring means for measuring the volume of the flowing media wherein the measuring means utilizes at least two buses. The first bus is utilized for communicating data within the measuring means and the second bus is utilized for communicating data external of the measuring means.

The present invention, in yet another form thereof, is an apparatus for measuring the volume of a flowing media. The apparatus includes a memory connected to a first bus. A processor is connected to the first bus. A second bus and a temperature sensor are connected to the processor. Also, a pulse sensor for sensing the volume pulses is connected to the processor. A device is connected to the second bus.

The present invention, in yet another form thereof, is a method for measuring the volume of a flowing media. The first step of the method is providing a housing having a temperature sensor and a measuring device wherein the temperature sensor is thermally insulated from the housing. The second step is utilizing the temperature sensor to measure the temperature of the flowing media. The third step is generating a table of values in the measuring device. The final step of the method is utilizing the table of values and the temperature of the flowing media to measure the volume of the flowing media.

The present invention, in yet another form thereof, is a method for measuring the volume of a flowing media. The method begins with the step of providing a housing having a temperature sensor and a measuring device. The second step is utilizing the temperature sensor to measure the temperature of the flowing media wherein the temperature sensor creates a resistance corresponding to the temperature of the flowing media. The third step is changing the resistance to ensure an accurate measurement of the temperature of the flowing media. The fourth step of the method is generating a table of values in the measuring device. The final step of the method is utilizing the table of values and the temperature of the flowing media to measure the volume of the flowing media.

The present invention, in yet another form thereof, is a method for measuring the volume of a flowing media. The method begins with the step of providing a meter having a housing wherein the housing has an external segment and an internal segment. The external segment has a single opening. The next step of the method is inserting a measuring device into the single opening of the external segment wherein the measuring device has a pulse sensor and a temperature sensor. The third step of the method is utilizing the temperature sensor to measure the temperature of the flowing media. The fourth step of the method is utilizing the pulse sensor to measure volume pulses of the flowing media. The fifth step of the method is generating a table of values in the measuring device. The final step of the method is utilizing the table of values and temperature of the flowing media to measure the volume of the flowing media.

The present invention, in yet another form thereof, is a method for measuring the volume of the flowing media. The first step of the method is providing a measuring device to measure the volume of the flowing media. The measuring device has at least two buses. The next step of the method is utilizing the first bus for communication data within the measuring device. The third step of the method is utilizing the second bus for communication of data external of the measuring device. The fourth step of the method is utilizing the temperature sensor to measure the temperature of the flowing media. The fifth step of the method is generating a table of values in the measuring device. The final step of the method is utilizing the table of values and temperature of the flowing media to measure the volume of the flowing media.

An advantage in one form of the present invention is the ability to change the output from the thermistor resistance allows for the use of less expense thermistors while continuing to ensure the accuracy of the reading of the thermistor.

Another advantage of the present invention is by utilizing an Electrically Erasable Programmable Read-only Memory (EEPROM) for the memory and an Inter-Integrated Circuit (IIC) bus to connect to the processor, the tables of values stored in the memory chip can be updated and accessed without removing the memory chip from the measuring device.

A third advantage of the present invention is that by having a one piece structure, only one opening needs to be manufactured or drilled into the meter housing where the media is flowing. By only having one opening in the meter housing, the meter housing is less expensive to manufacture and limits the amount of potential leakage of flowing media from the meter housing.

A fourth advantage in one form of the present invention is that by thermally insulating the thermistor and thermistor leads from the housing, a more accurate reading from the thermistor is ensured.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematic view of one form of the present invention;

FIG. 2 is a sectional view of the meter housing and the thermistor in the flowing media in one form of the present invention;

FIG. 3 is a sectional view of the meter housing and the thermistor in the flowing media in another form of the present invention;

FIG. 4 is a sectional view of the meter housing and the thermistor in the flowing media in another form of the present invention;

FIG. 5 is a sectional view of the meter housing and the thermistor in the flowing media in another form of the present invention;

FIG. 6 is a sectional view of the meter housing and the thermistor in the flowing media in another form of the present invention;

FIG. 7 is a sectional view of the meter housing and the thermistor in the flowing media in another form of the present invention;

FIG. 8 is a sectional view of the meter housing and the thermistor inserted into the opening of the meter housing in one form of the present invention;

FIG. 9 is a sectional view of the opening on the meter for insertion of the measuring apparatus in one form of the present invention;

FIG. 10 is a sectional view of the measuring device inserted into the opening of the meter in one form of the present invention;

FIG. 11 is a sectional view of the measuring device inserted into the opening of the meter in another form of the present invention; and

FIG. 12 is a flowchart of one form of the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

In one form of the present invention, a housing 20 for a meter 22 wherein meter 22 measures the flow of fuel for a fuel dispenser. Meter 22 can be an axial flow meter but is not limited to being an axial flow meter. U.S. Pat. No. 6,089,102 describes an axial flow meter and is herein incorporated by reference. Meter 22 is not limited to being located in a fuel dispenser and can be used in other devices that necessitate measuring the volume of flowing media.

Housing 20 has a temperature sensor 24 and a measuring means 28. Temperature sensor 24 is a thermistor that has leads 26 connected to measuring means 28. Temperature sensor 24 is not limited to being a thermistor. Temperature sensor 24 and leads 26 are thermally insulated from housing 20. The thermal insulation is a combination of Nylon, Aluminum and Copper. Other elements or combinations of elements can be used for the thermal insulation as well.

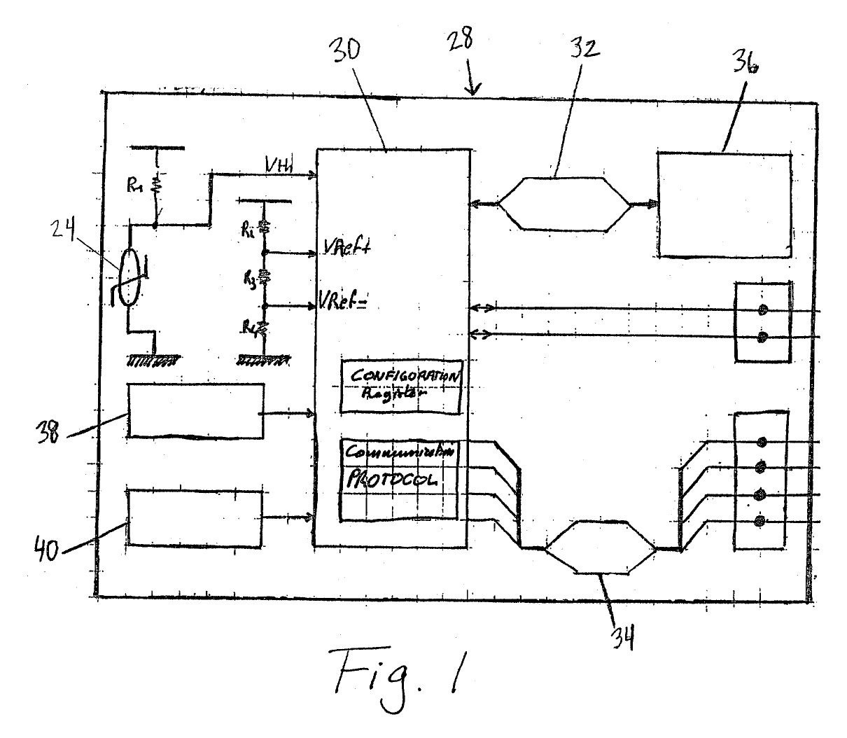

As shown in FIG. 1, measuring means 28 is connected to temperature sensor 24. Measuring means 28 has a processor 30, a first bus 32, a second bus 34, a memory 36, a first pulse sensor 38 and a second pulse sensor 40. First bus 32 and second bus 34 are IIC buses. First bus 32 and second bus 34 can be different types of buses such as Control Area Network (CAN) buses. Memory 36 is an EEPROM, but other types of memory such as flash memory can be used. First pulse sensor 38 and second pulse sensor 40 are Hall-Effect sensors. Measuring means 28 can have one or more Hall-Effect sensors. Other types of pulse sensors can be used as well.

Processor 30 is connected to nozzle boot switch 48. Nozzle boot switch 48 is used to indicate the beginning and ending of the fueling process based on the position of the nozzle in relation to nozzle boot switch 48. When nozzle boot switch 48 is activated, the present invention begins the volume computing process described herein. When nozzle boot switch 48 is deactivated, the volume computing process concludes with the total computations transmitted to external device 46 for display to a customer.

Memory 36 has a temperature look-up table of values (herein after referred to as temperature table) and a volume look-up table of values (herein after referred to as volume table). The temperature table is used to translate the resistance reading from temperature sensor 24 into a temperature reading. Based on the type of temperature sensor 24, the temperature table can send an instruction to processor 30 to activate resistance compensation means 42 to change the resistance communicated by temperature sensor 24 to processor 30. This change in the resistance will ensure an accurate temperature reading when the resistance is translated by processor 30 utilizing the temperature table.

The volume table stored on memory 36 is used to adjust the volume reading based on the temperature of the fuel, unaccounted for fuel moving around the outside of the meter, the viscosity of the fuel and other predetermined parameters can be used to adjust the volume reading for an accurate reading of the volume of the fuel. The volume table and temperature table are accessed by processor 30 each time a pulse is sensed by first pulse sensor 38 and second pulse sensor 40. The invention is not limited to accessing the tales each time a pulse is sensed. It can be every third pulse or any number of pulses as desired.

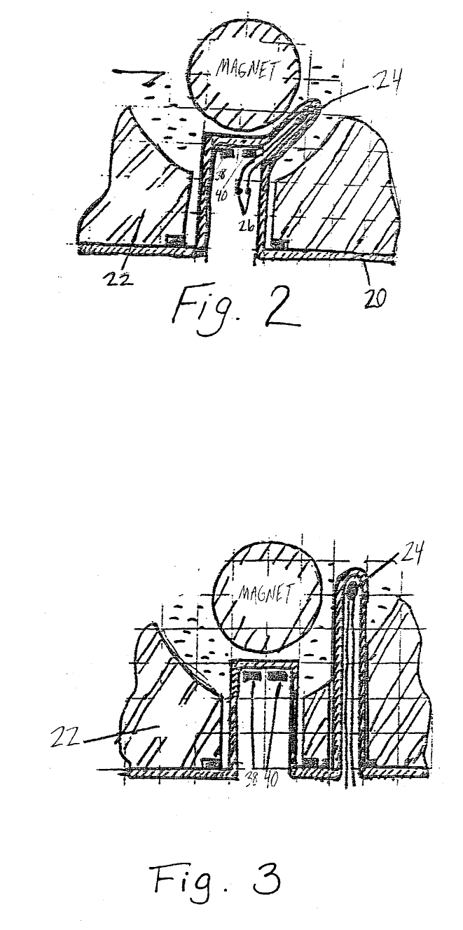

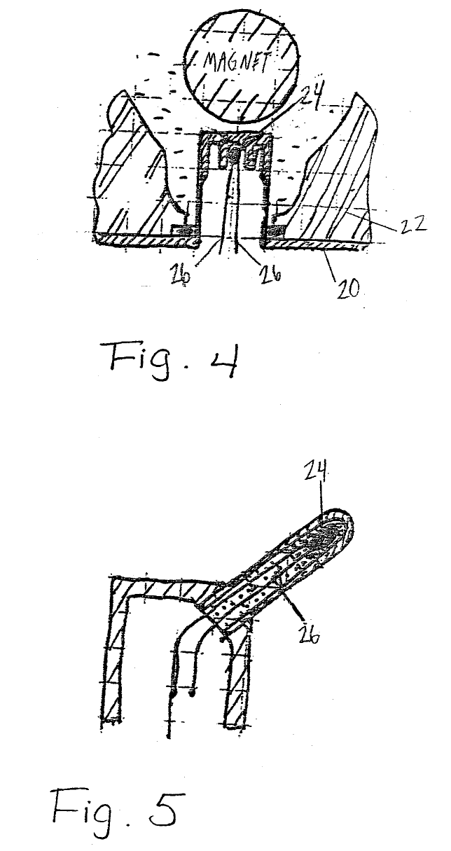

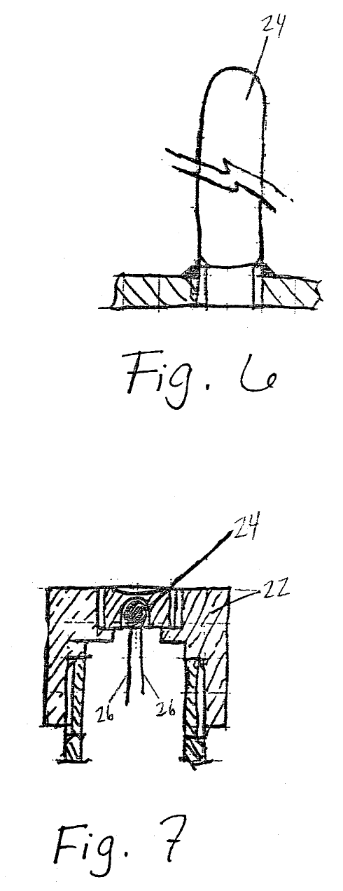

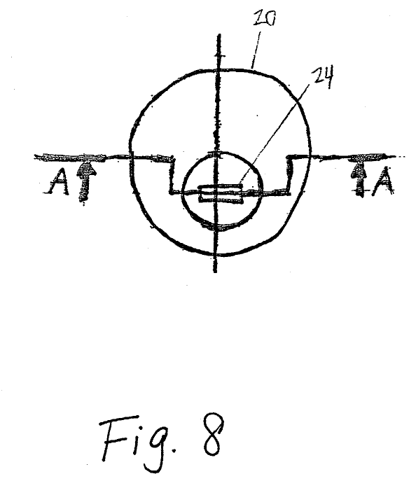

Temperature sensor 24 can be located in different locations of housing 20. Some examples of the positioning of temperature sensor 24 in housing 20 are shown in FIGS. 2-8. These examples are not meant to be limiting and different placements for temperature sensor 24 in housing 20 can be used. As was described above, temperature sensor 24 is in contact with the fuel and temperature sensor 24 creates a particular resistance based on the temperature of the fuel. Temperature sensor 24 is connected to processor 30. Processor 30 retrieves the resistance reading from temperature sensor 24.

Processor 30 is connected to first bus 32 and first bus 32 is connected to memory 36. Processor 30 utilizes the temperature table in memory 36 to translate the resistance reading into the temperature reading of the fuel. As was described above, based on the type of temperature sensor 24 utilized, the temperature look-up table may include an instruction for processor 30 to activate resistance compensation means 42 to change the resistance being read from temperature sensor 24 to ensure an accurate temperature translation from the temperature table.

R₁ of resistance compensation means 42 is utilized to polarize temperature sensor 24 to obtain the most linear response in a range of negative 40° Celsius to 30° Celsius. R₂, R₃ and R₄ are utilized to make minor resistance changes, such as 0.01, to the resistance retrieved by processor 30. The description of R₂, R₃ and R₄ as changing the resistance by 0.01 is for demonstration purposes only and is not meant to be limiting to the invention. R₂, R₃ and R₄, can make changes greater than or less than 0.01 to the resistance retrieved by processor 30 from temperature sensor 24.

First pulse sensor 38 and second pulse sensor 40 are connected to processor 30. Each time a pulse is detected from pulse sensor 38 and second pulse sensor 40, processor 30 activates temperature sensor 24 to measure the temperature of the fuel. Also, processor 30 utilizes the volume table located on memory 36 and based on the temperature of the fuel, the volume can be determined for each pulse. Processor 30 calculates an incremental increasing volume total starting from zero gallons for each pulse detected by processor 30.

If processor 30 retrieves a temperature change from temperature sensor 24 for a predetermined amount of time and processor 30 does not retrieve any pulses sensed by first pulse sensor 38 and second pulse sensor 40, processor 30 de-activates nozzle boot switch 48 to stop the dispensing of the fuel. The reason for processor 30 stopping the dispensing of fuel is that by having a change of temperature for a predetermined amount of time without any pulses being sensed, is an indication that first pulse sensor 38 and/or second pulse sensor 40 are not working properly. Without stopping the fuel being dispensed when the pulse sensors are not working properly is that fuel is being dispensed and the volume being dispensed is not being detected by meter 22 and therefore, the fuel is being dispensed at no cost.

Processor 30 is connected to second bus 34 and second bus 34 is connected to an external device 46 such as a display. Processor 30 transfers the volume measurement to external device 46 for each pulse and/or the total volume measured. Therefore, external device 46 can display an incremental increase in the total of gallons for the fuel is being dispensed. Processor 30 can also transfer other data such as the pre-adjusted measured volume and temperature for each pulse to external device 46. This list of data that can be transferred to the external device is not meant to be limiting and other data such as resistance readings can be transferred as well.

Both the temperature table and the volume table can be updated when necessary. To update either or both of the tables, memory 36 is erased and external device 46 will transfer the updated tables to second bus 34. Second bus 34 transfers the updated tables to processor 30. The tables are then transferred to memory 36 utilizing first bus 32. This ability to update the tables immediately allows for more accurate volume calculations.

For each fueling transaction, it is preferred that processor 30 erases the previous transaction and therefore the calculation for the new transaction will start with zero gallons of fuel. Processor 30 can form and save to memory the sum total of all fluid measured to enable diagnostic and lifetime calculations to be accomplished.

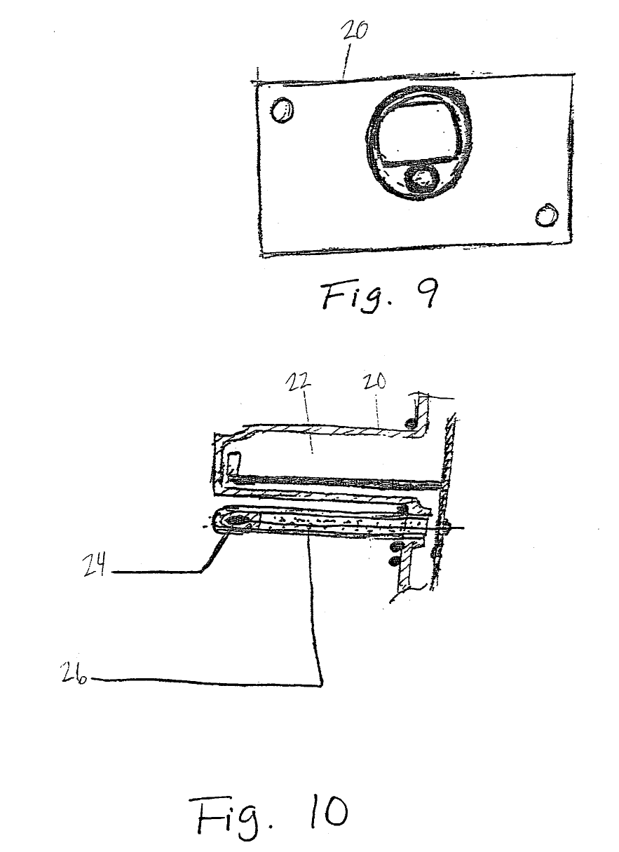

In another form of the present invention, housing 20 for meter 22 has an internal segment (not shown) and an external segment 44. The internal segment of housing 20 is utilized for fuel flow and external segment 44 of housing 20 has a single opening so that measuring means 28 can be inserted into the single opening of external segment 44. External segment 44 and the single opening are shown in FIG. 9.

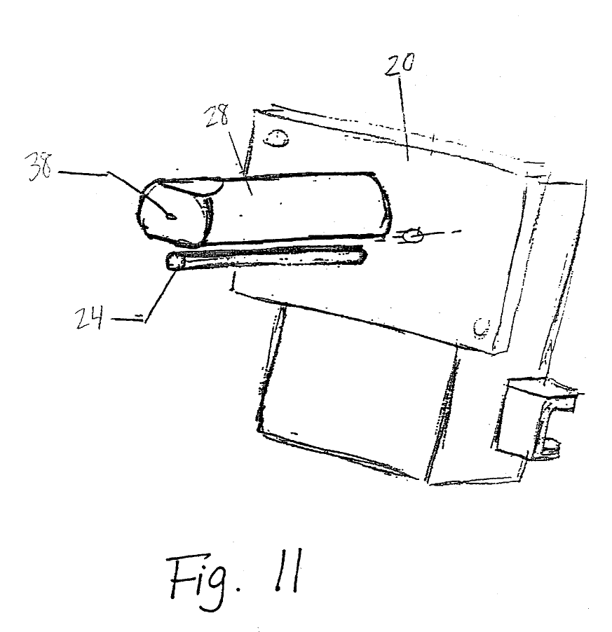

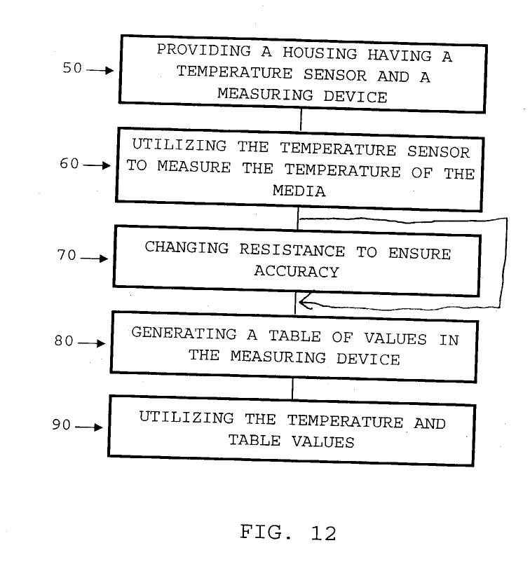

Measuring means 28 is formed as a single piece to be inserted into the single opening in external segment 44 as shown in FIGS. 10 and 11. Once measuring means 28 is securely fit into external segment 44, the volume of the fuel can be measured in the same way as described in the first embodiment of the present invention.

The present invention, in yet another form thereof, is a method of measuring the volume of a flowing media as shown in FIG. 12. The first step of the method is providing (40) a housing having a temperature sensor and a measuring device. The temperature sensor is thermally insulated from the housing in one form of the invention.

The second step of the method is utilizing (60) the temperature sensor to measure the temperature of the flowing media. The flowing media is fuel but other types of flowing media can be used. The temperature sensor is placed into the flowing media and based on the temperature of the flowing media, a resistance is created. The temperature sensor is a thermistor. Other types of temperature sensors can be used as well. In one form of the invention, the next step of the method is changing (70) the resistance, if necessary, to ensure an accurate measurement of the temperature of the flowing media. This change in the resistance reading is typically necessary with less expensive thermistors. The resistance is changed by either increasing or decreasing the resistance output from the temperature sensor.

The next step of the method is generating (80) a table of values in the measuring device. The table of values are the temperature table and the volume table. Other values can be utilized in the table as well. This table of values are used to adjust the output from the temperature sensor based on the type of resistor used. The table of values also contains any adjustments that need to be made to the volume calculations based on predetermined elements such as the viscosity of the fuel, fuel moving to the outside of the meter and not being accounted for by the meter and any other type of circumstance that would make the measuring of the volume inaccurate. The table of values is utilized to translate the resistance reading from the temperature sensor to a corresponding temperature reading to be used by the measuring device to measure the volume of the flowing media. Also, the measuring device has at least one pulse sensor and each time a pulse occurs, the temperature is read from the temperature sensor.

Once the measuring device senses a pulse, the next step of the method is utilizing (90) the table of values and the temperature of the flowing media to measure the volume of the flowing media. These values are stored in the measuring device and based on the temperature and the number of pulses, the volume of the flowing media can be measured. Once the volume of the flowing media is measured, the volume reading can be sent to an external device such as a display so that the person pumping the flowing media can monitor how many gallons they are pumping as each pulse is sensed.

In one form of the invention, the components of the measuring device are connected to a first bus and a second bus. The components to the measuring device are a processor, pulse sensor and memory. Other components can be used as well. The measuring device is connected to the temperature sensor so that the measuring of the flowing media can occur. The first bus is used to communicate data between the components of the measuring device so that there is an accurate measurement of the volume of the flowing media. The second bus is utilized for transferring the results of the calculations of the volume of the flowing media to an external device such as a display. The first and second bus are IIC buses. Other types of buses such as CAN buses can be used as well. The second bus also is utilized to allow updates to the table of values from an external device. These updates allow for the most up-to-date table of values and therefore the measurement of the flowing media can be more accurately calculated.

The present invention, in yet another form thereof, is a method of measuring the volume of flowing media. The method begins with the step of providing a meter having a housing wherein the housing has an external segment and an internal segment. The external segment has a single opening. The next step of the method is inserting a measuring device into the single opening of the external segment. The measuring device has a temperature sensor. The measuring device also has a pulse sensor, memory, processor as well as other components. The measuring device is formed as a single piece to fit into the single opening of the external segment. Once the measuring device is inserted into the single opening, the measuring device can measure the flow of the media in the same manner as was described in the previous embodiments.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An apparatus for measuring the volume of flowing media, said apparatus comprising:
a housing having a temperature sensor and a measuring means, said temperature sensor and said measuring means connected, said temperature sensor is utilized to measure the temperature of the flowing media, said temperature sensor is thermally insulated from said housing, said measuring means utilizing the measured temperature of the flowing media to measure the volume of the flowing media.

2. An apparatus for measuring the volume of flowing media, said apparatus comprising:
a housing having a temperature sensor and a measuring means, said temperature sensor and said measuring means connected, said temperature sensor is utilized to measure the temperature of the flowing media, said temperature sensor creating a resistance corresponding to measured temperature of flowing media, said measuring means utilizing the measured temperature of the flowing media to measure the volume of the flowing media; and
a resistance compensation means connected to said measuring means for changing the resistance of said temperature sensor to ensure an accurate measurement of the temperature of the flowing media.

3. An apparatus for measuring the volume of flowing media, said apparatus comprising:
a meter having a housing, said housing having an external segment and an internal segment, said external segment having a single opening; and
a measuring means having a pulse sensor and a temperature sensor, said measuring means is utilized to measure the volume of flowing media inserted into the single opening of said external segment.

4. An apparatus for measuring the volume of flowing media, said apparatus comprising:
a measuring means for measuring the volume of the flowing media, said measuring means utilizing at least two buses wherein said first bus is utilized for communicating data within said measuring means and said second bus is utilized for communicating data external of said measuring means.

5. An apparatus for measuring the volume of flowing media, said apparatus comprising:
a memory connected to a first bus;
a processor connected to said first bus;
a second bus connected to said processor;
a temperature sensor connected to said processor;
a pulse sensor for sensing volume pulses connected to said processor; and
a device connected to said second bus.

6. A method of measuring the volume of flowing media, said method comprising the steps of:
providing a housing having a temperature sensor and a measuring device, said temperature sensor is thermally insulated from said housing;
utilizing said temperature sensor to measure the temperature of the flowing media;
generating a table of values in said measuring device; and
utilizing the table of values and the temperature of flowing media to measure the volume of the flowing media.

7. A method of measuring the volume of flowing media, said method comprising the steps of:
providing a housing having a temperature sensor and a measuring device;
utilizing said temperature sensor to measure the temperature of the flowing media, said temperature sensor creating a resistance corresponding to the temperature of the flowing media;
changing the resistance to ensure an accurate measurement of the temperature of the flowing media;
generating a table of values in said measuring device; and
utilizing the table of values and the temperature of flowing media to measure the volume of the flowing media.

8. A method of measuring the volume of flowing media, said method comprising the steps of:
providing a meter having a housing, said housing having an external segment and an internal segment, said external segment having a single opening;
inserting a measuring device into the single opening of said external segment, said measuring device having a temperature sensor and a pulse sensor;
utilizing said temperature sensor to measure the temperature of the flowing media;
utilizing said pulse sensor to measure volume pulses of the flowing media;
generating a table of values in said measuring device; and
utilizing the table of values and temperature of the flowing media to measure the volume of the flowing media.

9. A method of measuring the volume of a flowing media, said method comprising the steps of:
providing a measuring device to measure the volume of the flowing media, said measuring device having at least two buses, said measuring device having a temperature sensor;
utilizing said first bus for communication of data within said measuring device;
utilizing said second bus for communication of data external of said measuring device;
utilizing said temperature sensor to measure the temperature of the flowing media;
generating a table of values in said measuring device; and
utilizing the table of values and temperature of the flowing media to measure the volume of the flowing media.
